(19) United States
(12) Patent Application Publication
(10) Pub. No.: US 2024/0237610 A1
(43) Pub. Date: Jul. 18, 2024

(54) BALE FEEDER

(71) Applicants: Benjamin Glade Casper, Basin City, WA (US); Lanny Rhody Hayes, Mesa, WA (US)

(72) Inventors: Benjamin Glade Casper, Basin City, WA (US); Lanny Rhody Hayes, Mesa, WA (US)

(21) Appl. No.: 18/416,867

(22) Filed: Jan. 18, 2024

Related U.S. Application Data
(60) Provisional application No. 63/480,479, filed on Jan. 18, 2023.

(51) Int. Cl. A01K 5/00

(52) U.S. Cl. CPC A01K 5/005

(57) ABSTRACT

An apparatus comprising a frame configured for placement on a bed of a motor vehicle; a sliding assembly to move a bale of feed product placed within or on the frame; a motor to cause a sprocket to turn; and a chain to attach the sprocket to the sliding assembly, the chain to transfer force supplied by the motor from the sprocket to the sliding assembly to move the bale towards a rear of the frame to dispense a portion of the bale.

### CROSS-REFERENCES TO RELATED APPLICATIONS

This application claims priority to, and the benefit of, U.S. Provisional Application No. 63/480,479, filed Jan. 18, 2023, which is incorporated herein by reference.

### BACKGROUND

Baled feed product (e.g., hay, straw, etc.) is frequently fed to livestock such as cattle, especially when grass has been grazed away and the cold of winter prevents vegetative growth. Compressed bales with rectangular (e.g., square) cross sections are typically dispersed manually from the back of a trailer or truck. Such feeding may be difficult for livestock owners such as hobby farmers or small herd operators that struggle with physical limitations and don't have adequate outside help. Injuries from strenuous feeding of heavy flakes from a bale, such as slipping off a snowy or icy bale platform or falling off a moving vehicle carting the bale, are common and unnecessary. Bale feeder trailers have been utilized to ameliorate some of these issues, but are costly, difficult to ship to the end user, and may present size and maneuvering difficulties.

### BRIEF DESCRIPTION OF THE DRAWINGS

FIG. 1 illustrates a bale feeder mounted on a motor vehicle in accordance with any of the embodiments described herein.

FIG. 2 illustrates a side perspective view of a bale feeder in accordance with any of the embodiments described herein.

FIG. 3 illustrates a rear perspective view of a bale feeder in accordance with any of the embodiments described herein.

FIG. 4 illustrates a side view of a bale feeder in accordance with any of the embodiments described herein.

FIG. 5 illustrates a rear view of a bale feeder in accordance with any of the embodiments described herein.

FIG. 6 illustrates a rear sprocket and chain of a bale feeder in accordance with any of the embodiments described herein.

FIG. 7 illustrates a rear perspective view of a chain on a sprocket of a bale feeder in accordance with any of the embodiments described herein.

FIG. 8 illustrates a front sprocket and chain in accordance with any of the embodiments described herein.

FIG. 9 illustrates a bale feeder being loaded in accordance with any of the embodiments described herein.

FIG. 10 illustrates a portion of a bale being dispersed by a bale feeder in accordance with any of the embodiments described herein.

FIG. 11 illustrates a rear perspective view of a dual capacity bale feeder in accordance with any of the embodiments described herein.

FIG. 12 illustrates a dual capacity bale feeder loaded with two bales in accordance with any of the embodiments described herein.

### DETAILED DESCRIPTION

Various embodiments of the present disclosure provide a bale feeder that may be mounted on a motor vehicle, such as a pickup or flatbed truck. A modular nature of the bale feeder may allow it to be shipped in a relatively inexpensive and expedient manner and may allow the bale feeder to be assembled quickly. For example, the frame of the bale feeder may comprise discrete portions that allow the bale feeder to be shipped on a pallet or in a box.

The bale feeder may be easily and quickly mounted on the vehicle by bolting, chaining, clamping, or otherwise attaching the bale feeder to the vehicle. The mounting of the bale feeder onto a motor vehicle may result in much easier maneuvering of the bale feeder relative to a bale feeder on a trailer that is pulled behind a motor vehicle.

The bale feeder may also be easily and quickly removed from the motor vehicle. For example, at least in some embodiments, the bale feeder is not fabricated permanently onto a motor vehicle and may be removed at the end of the feeding season or when feeder is otherwise not needed. The frame of the bale feeder may be collapsible and allow for separation and reduction when disassembled. In some embodiments, any or a combination of flanges, pockets, couplers, clamps, collars, inserts, bolts and nuts, or hinges may be used to couple or secure ends of respective components of the frame.

In various embodiments, the bale feeder may dispense a single bale (e.g., of hay, grass, straw, etc.) at a time or two bales simultaneously. In some embodiments, the bale feeder may disperse portions of bales from the vehicle via a corded or wireless controller, allowing an operator fine control over the rate of dispersion.

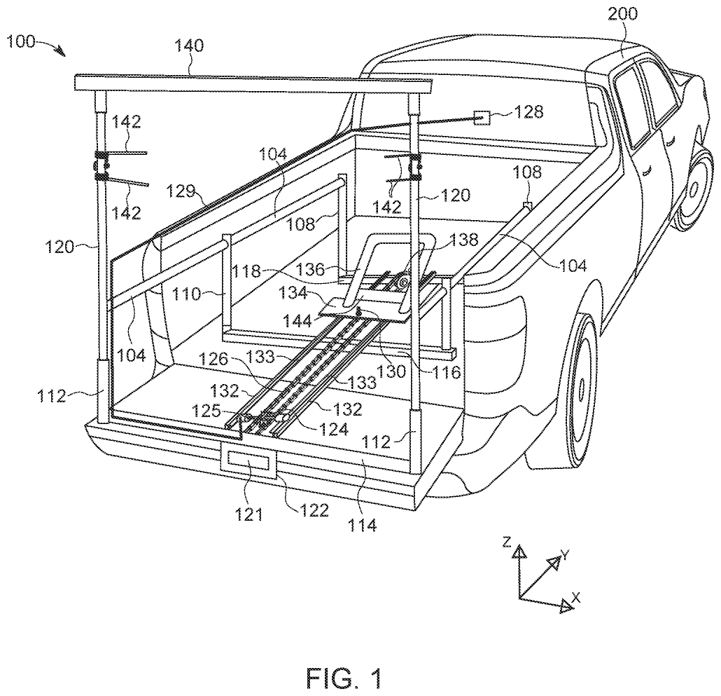

FIG. 1 illustrates a bale feeder 100 mounted on a motor vehicle 200 in accordance with any of the embodiments described herein. In various embodiments of the present disclosure, a bale feeder 100 may be disposed on a portion (e.g., a bed) of a motor vehicle 200, such as a pickup truck or flatbed truck, and may be selectively secured to the motor vehicle 200 by bolts, chains, clamps or other attachment mechanisms or fixedly secured to the motor vehicle 200 (e.g., by welding or other attachment mechanisms).

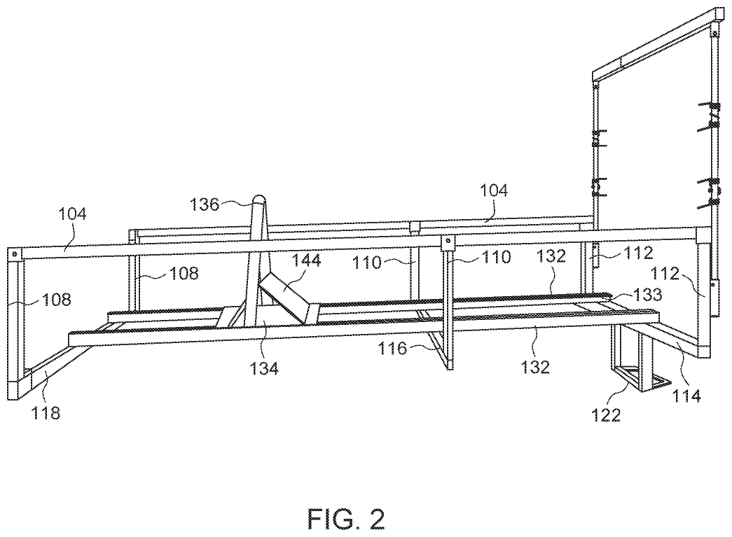

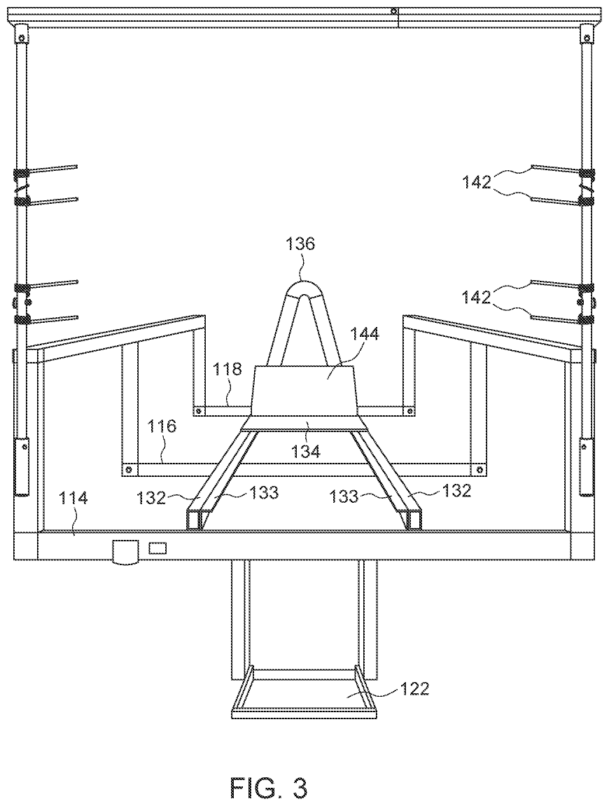

FIG. 2 illustrates a side perspective view of the bale feeder 100 in accordance with any of the embodiments described herein. FIG. 3 illustrates a rear perspective view of the bale feeder 100 in accordance with any of the embodiments described herein.

Jointly referring to FIGS. 1-3, the frame of the bale feeder 100 may comprise a plurality of cross members, such as rear cross member 114, middle cross member 116, and front cross member 118. The cross members may collectively provide a stationary base for bale feeder 100. The cross members may be constructed out of tubular metal (e.g., steel) that has an annular shape or a rectangular border (with a hollow interior) as a cross section or other suitable material having any suitable shape. In various embodiments, the length of the cross members (e.g., extending in the x-direction) may generally be much greater than the height (e.g., in the z-direction) or width (e.g., in the y-direction) of the cross members. In various embodiments, the different cross members may have substantially equal dimensions. In various embodiments, the cross members may have lengths that are based on (e.g., substantially equal to a width of a bale to be placed on the cross members). In some embodiments, the middle cross member 116 is equidistant from the rear cross member 114 and the front cross member 118, although other arrangements are contemplated.

Frame members 132 may generally span the length of the bale feeder 100. The frame members may have lengths that extend in a direction (e.g., the y-direction) generally orthogonal to the cross members 114, 116, 118. Frame members 132 may be constructed out of tubular metal (e.g., steel) that has an annular shape or rectangular border (with a hollow interior) as a cross section or other suitable material having any suitable shape. The frame members may be attached to the cross members via fasteners, bolts, welds, or other attaching methods. In various embodiments, the frame members 132 may be disposed on top of the cross members.

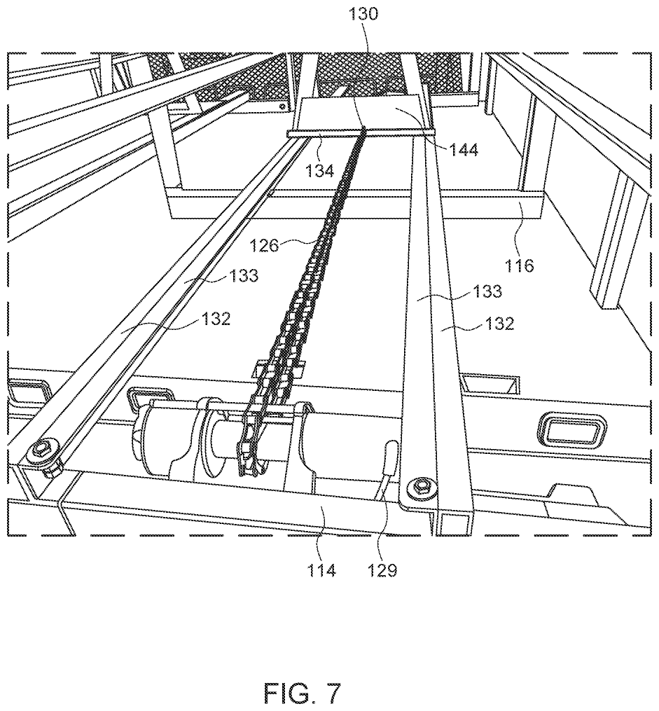

Angle members 133 may be attached to the frame members 132 and/or the cross members. In some embodiments, the angle members 133 are welded to the frame members 132 and are adjacent to the frame members 132. An angle member may include a first section (which has a top surface that is substantially rectangular) along its length (e.g., in the y-direction) and a second section (which has a side surface that is substantially rectangular) along its length that is disposed at an angle (e.g., substantially 90 degrees) to the first portion. In various embodiments, the second section of a frame member 132 is in contact with or otherwise immediately adjacent to a corresponding side of an angle member 133 along the length of the frame member 132 (see, e.g., FIGS. 3 and 7). The bottom surface of the section sections of the angle members 133 may contact or be otherwise adjacent to the cross members 114, 116, 118. The top side of an angle member 133 may be generally flush with (e.g., the same height as) the top side of the adjacent frame member 132.

The bale feeder 100 may also include a slider assembly. The slider assembly may include a slider base 134 and a slider rack 136. In operation, the slider rack 136 may exert pressure against a bale loaded in the bale feeder 100 to push the bale towards the rear of the bale feeder 100 during dispersion of the bale. Slider base 134 may function as a platform for the slider rack 136. The slider rack 136 may extend upwards from the slider base 134 at the base of the slider rack 136 which rests on the slider base 134. The slider rack 136 may take on various shapes. In some embodiments, the slider rack 136 may include a pair of segments that extend upward (and optionally in a lateral direction as well) from the slider base 134 and are joined together by a lateral segment (where the lateral segment may optionally also extend in the vertical direction) at the top of the slider rack 136. In other embodiments, one or more segments may extend upward (an optionally in a lateral direction) from the slider base. Thus, the segments of the slider rack 136 may extend straight up or upwards at an angle from the slider base 134. In some embodiments, the slider base 134 may comprise a plate with a generally rectangular top surface.

In some embodiments, an angle rack 144 may be placed on the slider base 134. For example, the angle rack 144 may be attached to the slider base 134 and the slider rack 136. In various embodiments, the angle rack 144 may be more rearward than the slider rack 136 (as depicted in FIG. 1) or more forward than the slider rack 136 (as depicted in FIGS. 2 and 3). In various embodiments, the angle rack 144 may comprise a plate with a generally rectangular top and bottom surface. In various embodiments, the angle rack 144 may extend upward from the slider base 134 at an angle towards the slider rack 136. The angle rack 144 may facilitate loading of the bale and may prevent a final portion of the bale from being stuck in a vertical position on the slider by facilitating rearward movement of the final portion.

Angle members 133 may constrain movement of the slider assembly between a forward and rearward trajectory (e.g., in the y direction), such that appreciable sideways movement of the slider assembly (e.g., in the x direction) is prevented. In some embodiments and as depicted in FIG. 5, the slider base 134 may include lips on its bottom that interface with the first sections (e.g., top sections) of the angle members 133 to hold the slider base 134 in position as the slider base 134 slides along the length of the angle members 133 and frame members 132. The lips may extend downwards proximate an inside edge of the angle members and then horizontally under at least a portion of the bottom surfaces of the first sections of the angle members. In some embodiments, slider base 134 has portions that encompass portions of angle members 133 both above and below the first sections of angle members 133 to stabilize the slider base 134 while allowing it to slide upon angle members 133 from the front to the rear of the bale feeder 100 and vice versa.

In operation, the slider assembly begins at or proximate the front of bale feeder 100 (e.g., closer to the front vertical supports 108) and moves toward the rear of bale feeder 100 (e.g., closer to the rear vertical supports 112), e.g., when dispensing portions of the bale from the rear of the bale feeder 100.

The frame may also include front vertical supports 108, middle vertical supports 110, and rear vertical supports 112 that are respectively attached to cross members 114, 116, and 118 by bolts, pockets, welds, and/or other attaching devices. These vertical supports extend generally upward from the cross members. These supports may provide fixtures for side rails 104 of the frame. Rear vertical supports 112 of the frame may also provide support for vertical extensions 120 and cross rack member 140 of the frame. Any of the vertical supports, side rails, vertical extensions, or cross rack members may be constructed out of tubular metal (e.g., steel) that has an annular shape or a rectangular border (with a hollow interior) as a cross section or other suitable material having any suitable shape. The rails may be affixed to each side of the bale feeder 100 and supported by the vertical supports. Such components may keep the bale from twisting or becoming stuck as the bale is pushed towards the rear of the bale feeder 100.

Spring tines 142 or other components may be attached to vertical extensions 120 and may face inward. In operation, flakes of a bale may be kept in place by such components (e.g., spring tines 142) until the slider assembly pushes a portion of the bale past the components (overcoming the inward force provided by the components) at which point a flake may be separated from the bale and dropped from the bale feeder 100 (e.g., onto the ground).

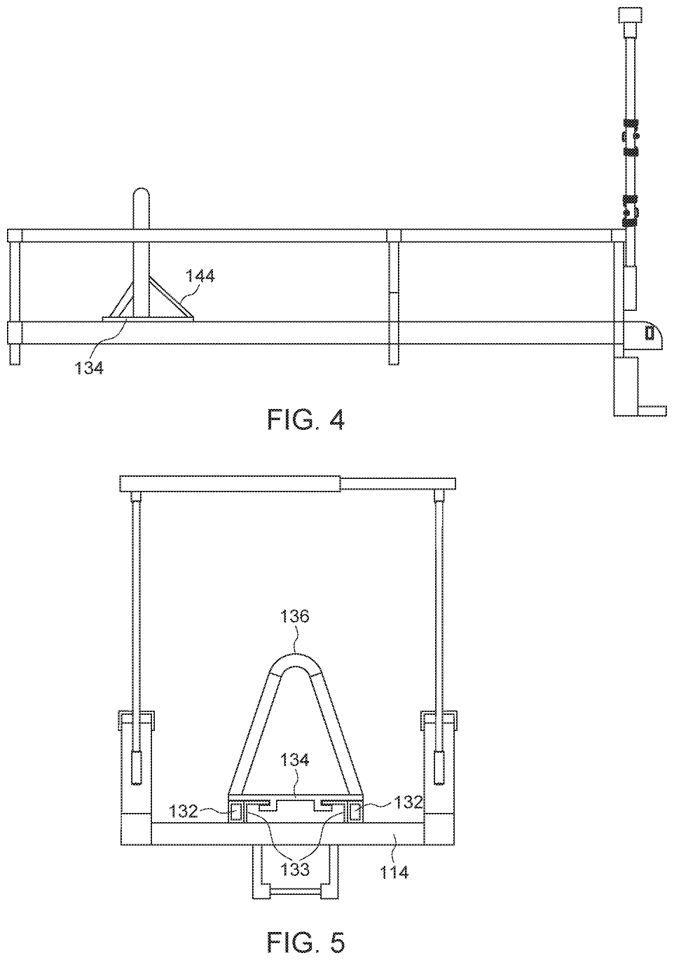

FIG. 4 illustrates a side view of a bale feeder in accordance with any of the embodiments described herein. FIG. 5 illustrates a rear view of a bale feeder in accordance with any of the embodiments described herein. These FIGS. may show alternative arrangements of various components of the bale feeder 100.

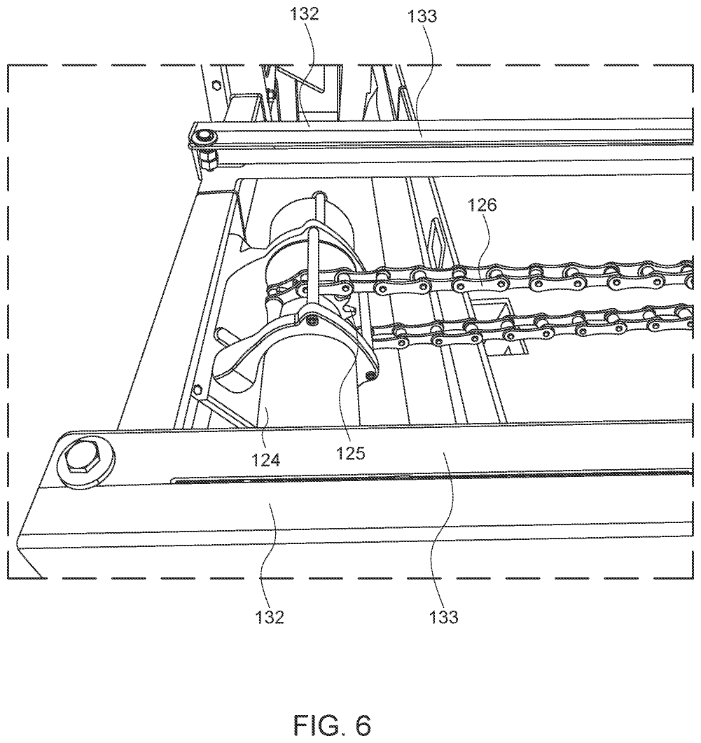

Referring jointly to FIG. 1 and FIG. 6, the bale feeder 100 may include an electrical assembly that controls movement of the slider assembly. The electrical assembly may include a controller 128, an electrical control cable 129, and motor 124. In other embodiments, the function of the electrical control cable 129 may be performed by a wireless transceiver. When controller 128 is activated (e.g., from the cab of the motor vehicle 200 by a driver or passenger), the electrical control cable 129 (e.g., through an electrical signal, mechanical coupling, etc.) may engage the motor 124 and drive sprocket 125 that is attached (directly or indirectly) to a shaft of the motor 124.

In some embodiments, the drive sprocket 125 may be attached to a winch spool (e.g., that is normally used to spool a cable). For example, drive sprocket 125 may include a center hole (e.g., which may be cut or machined) to wrap around and/or match the spool size. The sprocket may then be cut into two pieces (e.g., cut in half), placed around the winch spool, and then welded back together and onto the winch spool to secure the sprocket to the winch spool. Attaching the sprocket to the winch spool using this method is much easier than dismantling the winch, spool, shaft, frame and other fittings to fit the sprocket and then rebuilding or reassembling the winch and various other parts as needed. In other embodiments, the drive sprocket 125 may be coupled to the motor using any other suitable method, e.g., by direct attachment to the shaft or other component of the motor.

The controller 128 may be operable to cause the shaft of the motor to spin in a clockwise direction using a first signal and a counterclockwise direction using a second signal, and such movement may be transferred through the sprocket and chain to the slider assembly so as to cause the slider assembly to move forward or rearward as desired.

In some embodiments, the motor is a direct current motor, such as a 12 volt winch motor. A direct current motor (e.g., a 12 volt winch motor) may be commonly available, relatively inexpensive and compact, and suitably geared for unloading a bale using the appropriate speed and power.

In various embodiments, the motor is located proximate the rear of the bale feeder and the top of the motor 124 (and components attached to the motor such as the sprocket 125) is entirely below the tops of the frame members 132 and angle members 133. This may facilitate placement of the motor behind and lower than the bed of the vehicle 200, thus avoiding interference with the sliding of the bale during operation (e.g., the slider base 134 may pass over the motor 124, sprocket 125, and/or chain 126 as it moves the bale to the rear). The motor may comprise or be coupled to a motor frame that is attached to the rear cross member 114 or other structural component (e.g., of the frame) of the bale feeder 100 (or the motor may be directly attached to the rear cross member 114 or other structural component).

Electrical power to the motor may be provided by a battery 121 held in battery box 122 (or by other suitable power source, such as the electrical system of the motor vehicle 200). In the embodiment depicted, the battery box 122 is located at the rear of the bale feeder 100 and is attached to the frame (e.g., to the rear cross member 114). This may allow for a short electric cable run from the battery to the motor, thus avoiding the need for a longer or thicker electrical cable, heating up of a long cable run, and/or a loss of electrical efficiency as may be present on long cable runs.

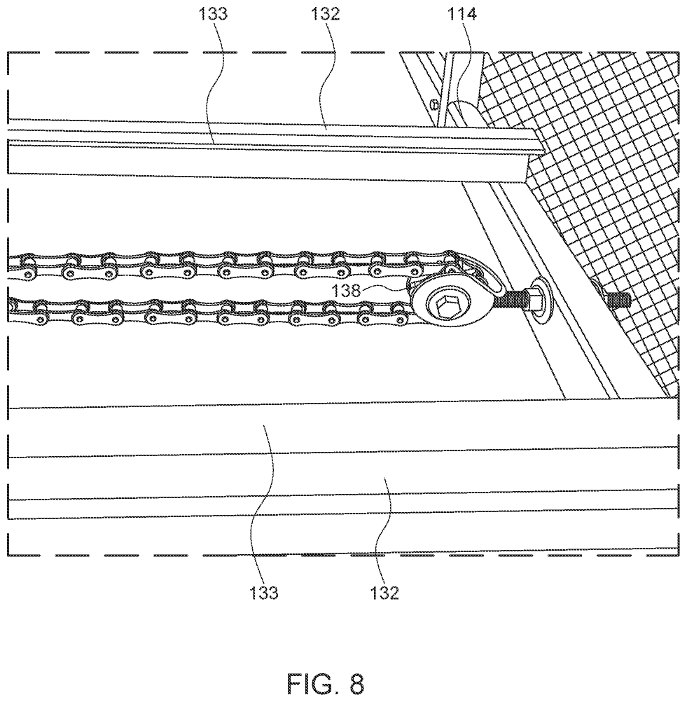

Referring jointly to FIGS. 1 and 6-8, when power is applied to the motor 124, the shaft of the motor 124 and the drive sprocket 125 begin turning. In various embodiments, the turning of the drive sprocket 125 in a particular direction pulls the top portion of roller chain 126 (which is in contact with the drive sprocket 125, e.g., is wrapped around the sprocket) toward the rear of bale feeder 100. A front sprocket 138 (e.g., which may rotate about a bearing that is not explicitly depicted) may also be in contact with roller chain 126 and may keep the roller chain 126 in place with suitable tautness. In some embodiments, the front sprocket may be attached to the front cross member 118 or other structural component (e.g., of the frame) of the bale feeder 100. The chain may rotate about drive sprocket 125 and front sprocket 138.

The slider assembly is connected to the roller chain 126 via connection 130. For example, a bolt may be placed up through a link of the chain and through the slider base 134 and secured by a nut on the top of the slider base. As another example, the chain may be welded to the slider base. Other suitable attachment mechanisms are contemplated herein. Thus, the slider base 134, slider rack 136, and the angle rack 144 are connected to the roller chain 126. Movement of the roller chain 126 causes the slider base 134 (and the connected slider rack 136 and angle rack 144) to begin a controlled slide on frame members 132 and angle members 133 towards the rear of the bale feeder 100.

When slider base 134, slider rack 136, and angle rack 144 reach the rear of feeder 100 and the bale has been completely dispensed, controller 128 may be operated to stop and/or reverse the direction of the shaft of the motor 124. The slider assembly may then be returned to the front of the feeder 100 by using controller 128 to cause the motor to reverse the direction of movement of the drive sprocket 125. When the slider assembly is returned to the front of the bale feeder 100, an additional bale may be placed within the bale feeder 100 if desired.

Thus, various embodiments may utilize a roller chain drive actuated by a motor to eliminate the need for clutches, hydraulic pumps and hoses, oil, and concomitant loss of efficiency. A chain drive may provide direct and instantaneous movement in forward and reverse. In other embodiments, a wire rope system with pulleys could be used in place of the chain drive.

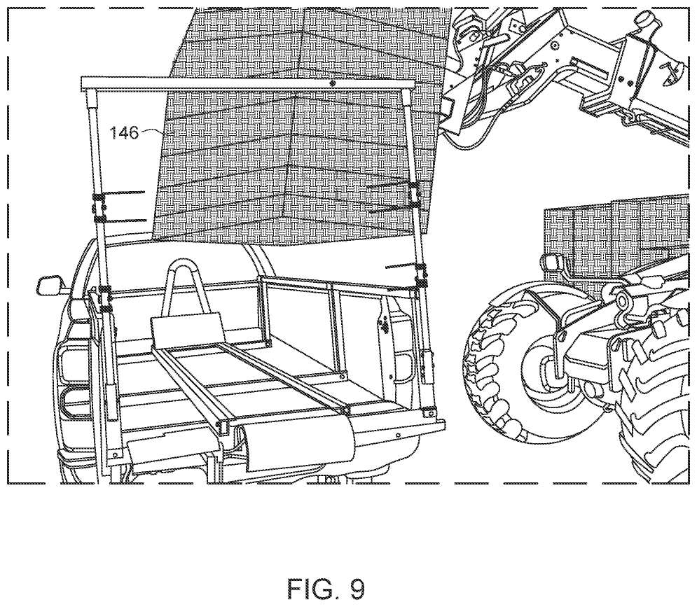

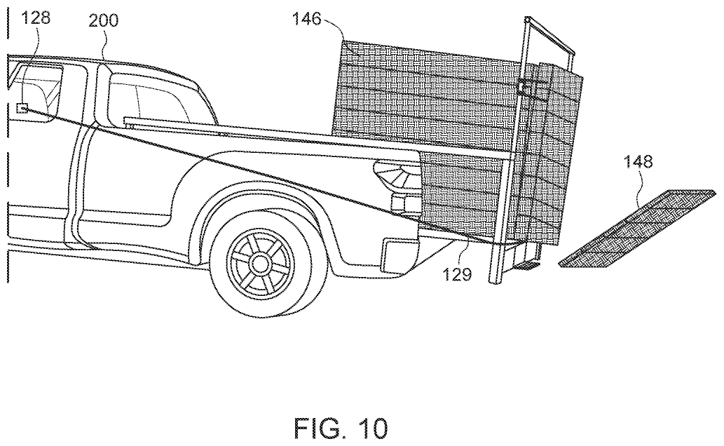

FIG. 9 illustrates a bale feeder 100 being loaded with a bale 146 in accordance with any of the embodiments described herein. In various embodiments, any suitable machine (e.g., a forklift, tractor, etc.) may be used to lift the bale 146 over the bed of the track and drop the bale within and/or onto the frame of the bale feeder 100.

FIG. 10 illustrates a portion (e.g., a flake) 148 of a bale 146 being dispersed by a bale feeder 100 in accordance with any of the embodiments described herein. When motor vehicle 200 is in a location to begin dispersion of the bale, holding twine on the bale 146 may be severed and the bale 146 is consequently loosened and ready to be dispersed. Slider rack 136 keeps the loosened hay bale in place at the front while spring tines 142 keep the rear of bale 146 in place. When controller 128 is activated, the motor 124 and drive sprocket 125 are engaged. As roller chain 126 pulls slider base 134, slider rack 136, and angle rack 144 towards the rear, a portion (e.g., a flake) 148 of bale 146 is pushed past spring tines 142, and the portion 148 of the bale 146 falls off behind the bale feeder 100 and drops to the ground and is thus available for livestock to feed on. Motor vehicle 200 may be driven in a generally forward motion as the bale 146 is pushed towards the rear of the bale feeder 100 such that the hay (or other material of the bale) is scattered out for livestock to feed.

In some embodiments, the base of the bale feeder features angle rack 144. When the bale is almost fully dispersed, the last portions (e.g., flakes) slide and drop downwards and rearwards across the angle rack as there is minimal resistance due to reduced contact area of the bale on the frame members 132 and the angle members 133. This ensures no large portions of the bale will be left on the feeder while allowing for more clearance area between the slider rack 136 at the front and the cross rack member 140 and vertical extensions 120 at the rear when loading the bale.

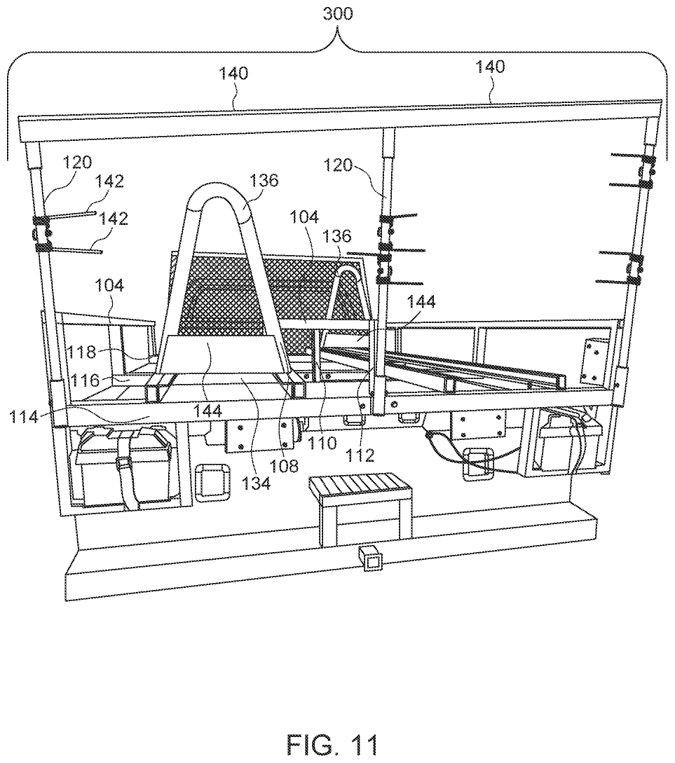

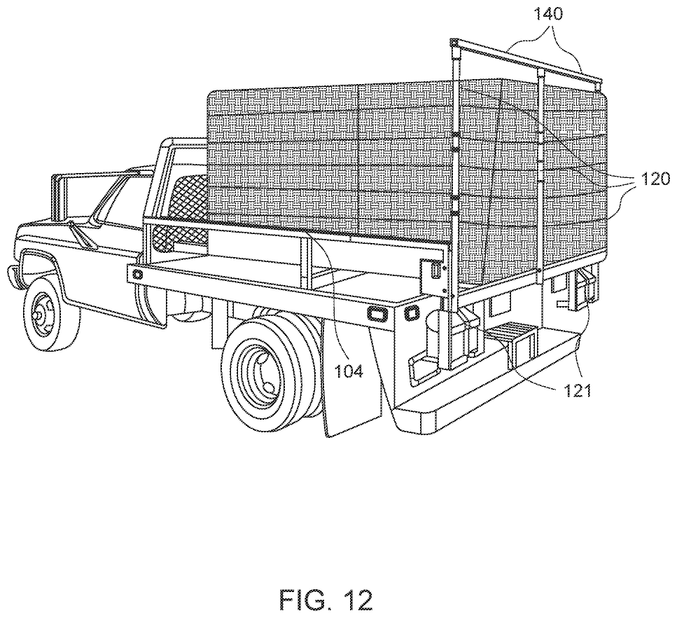

FIG. 11 illustrates a rear perspective view of a dual capacity bale feeder 300 in accordance with any of the embodiments described herein and FIG. 12 illustrates a dual capacity bale feeder loaded with two bales in accordance with any of the embodiments described herein.

Referring jointly to FIGS. 11-12, the bale feeder 300 may comprise two feeders allowing two bales to be fed concurrently or consecutively from one truck (e.g., a flatbed truck). Each feeder of the double bale feeder 300 may include any one or more of the components of the bale feeder 100 described herein. In some embodiments, a single front vertical support 108, middle vertical support 110, rear vertical support 112, and/or side rail 104 are located along the longitudinal sides and center of the double bale feeder 300. These components may interface with the sides (or portions thereof) of the respective inward and outward facing side of the bales. The center rail serves to guide bales on either side of it. On the feeder on the left side of FIG. 3, the slider assembly is located at the rear of feeder. On the feeder on the right side of FIG. 3, the slider assembly is located near the front of the feeder.

Rear cross members 114, middle cross members 116, and front cross members 118 may be cut, joined, connected or otherwise merged together with bolts, pockets, flanges, welds or other means at ends in middle section to complete a two bale feeder. In other embodiments, any pair of cross members may be replaced by a single cross member spanning the width of the double bale feeder 300.

In various embodiments, the control of the slider bases 134 may be operated independently. For example, each slider assembly may be powered by its own motor and chain. Thus, one bale may be dispersed at a time. In other embodiments, the slider bases 134 may be operated concurrently (e.g., may move together) using the same control mechanism (e.g., controller 128). Thus, a user may use the controller 128 to select the feeder to be operated and whether that feeder should move in the forward or rearward direction.

1. An apparatus comprising:
a frame configured for placement on a bed of a motor vehicle;
a sliding assembly to move a bale of feed product placed within or on the frame;
a motor to cause a sprocket to turn; and
a chain to attach the sprocket to the sliding assembly, the chain to transfer force supplied by the motor from the sprocket to the sliding assembly to move the bale towards a rear of the frame to dispense a portion of the bale.

2. The apparatus of claim 1, wherein the chain is further to transfer force supplied by the motor from the sprocket to the sliding assembly to move the sliding assembly toward a front of the frame.

3. The apparatus of claim 1, wherein the chain is secured to the sliding assembly at least in part by a bolt placed through a link of the chain.

4. The apparatus of claim 1, further comprising a controller to provide control signals to the motor to move the sliding assembly in a forward direction and in a rearward direction.

5. The apparatus of claim 1, further comprising a second sprocket to attach to the chain.

6. The apparatus of claim 5, wherein the second sprocket is to attach to the frame proximate a front of the frame.

7. The apparatus of claim 1, wherein the frame comprises a plurality of frame members that extend from proximate a rear of the frame to proximate a front of the frame.

8. The apparatus of claim 7, wherein the plurality of frame members are placed on and are generally orthogonal to a plurality of cross members that extend from proximate a first side of the frame to proximate a second side of the frame.

9. The apparatus of claim 1, wherein the frame comprises angle members, wherein the sliding assembly is to rest on the angle members and slide along the angle members, wherein the angle members each comprise a first portion and a second portion both extending in a first direction, wherein the first portions of the angle members are to support the sliding assembly and wherein the second portions of the angle members are generally orthogonal to the first portions of the angle members.

10. The apparatus of claim 9, further comprising a plurality of frame members that extend in the first direction, wherein a frame member of the plurality of frame members is adjacent to an angle member of the plurality of angle members and has a top surface configured to support the sliding assembly.

11. The apparatus of claim 9, wherein a base of the sliding assembly comprises a pair of sections that extend underneath the first portions of the of the angle members.

12. The apparatus of claim 1, wherein the sliding assembly comprises a base with a generally flat top surface.

13. The apparatus of claim 12, wherein the sliding assembly comprises a plurality of members extending upwards from the top surface of the base.

14. The apparatus of claim 13, wherein the sliding assembly comprises a section that is attached to the plurality of members and to the top surface of the base at an angle to the top surface of the base.
